(19) United States
(12) Patent Application Publication
(10) Pub. No.: US 2026/0045086 A1
(43) Pub. Date: Feb. 12, 2026

(54) METHOD AND APPARATUS FOR PROCESSING IMAGE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Zhenyu Zhang, Beijing (CN); Yi Song, Beijing (CN); Xiaotian Han, Beijing (CN); Shuohuan Wang, Beijing (CN); Yu Sun, Beijing (CN); Hua Wu, Beijing (CN)

(73) Assignee: BEIJING BAIDU NETCOM SCIENCE TECHNOLOGY CO., LTD., Beijing (CN)

(21) Appl. No.: 19/360,864

(22) Filed: Oct. 16, 2025

(30) Foreign Application Priority Data
Jun. 12, 2025 (CN) 202510788257.6

(51) Int. Cl. G06V 20/40; G06V 10/77; G06V 10/80

(52) U.S. Cl. CPC G06V 20/41; G06V 10/7715; G06V 10/806

(57) ABSTRACT

The disclosure provides a method and an apparatus for processing an image, an electronic device, and a storage medium, which relates to the field of artificial intelligence technologies, and particularly to a technical field such as computer vision, deep learning, and large-scale models. The solution includes: obtaining an input content adapted to an image processing task, in which the input content includes at least one of: a first text token sequence, a first image token sequence, or an image-text fusion sequence; obtaining a joint feature representation including multimodal semantic information by performing cross-modal semantic modeling on the input content, in which the multimodal semantic information indicates a semantic correlation relationship of the input content in different modalities; and generating an output content adapted to the image processing task based on the joint feature representation.

### CROSS-REFERENCE TO RELATED APPLICATION

This application claims priority to Chinese Patent Application No. 2025107882576, filed on Jun. 12, 2025, the entire content of which is incorporated herein by reference.

### TECHNICAL FIELD

The disclosure relates to the field of artificial intelligence technologies, and particularly to a technical field such as computer vision, deep learning, and large-scale models, and more particularly to a method and an apparatus for processing an image, an electronic device, and a storage medium.

### BACKGROUND

With the continuous development of artificial intelligence and computer vision technologies, an image processing task is no longer limited to a conventional single visual perception task, such as image classification, object detection, and image segmentation, but gradually expands to a more complex high-level application field, such as image understanding, fine image editing, and high-quality image generation. In this background, processing an image efficiently and accurately becomes a key for improving a quality of visual content generation and interactive experience, and has a significant research value and application importance.

### SUMMARY

According to a first aspect of the disclosure, a method for processing an image is provided, including:
obtaining an input content adapted to an image processing task, in which the input content includes at least one of: a first text token sequence, a first image token sequence, or an image-text fusion sequence;
obtaining a joint feature representation including multimodal semantic information by performing cross-modal semantic modeling on the input content, in which the multimodal semantic information indicates a semantic correlation relationship of the input content in different modalities; and
generating an output content adapted to the image processing task based on the joint feature representation.

According to a second aspect of the disclosure, an electronic device is provided, including:
at least one processor; and
a memory communicatively coupled to the at least one processor.

The memory stores instructions executable by the at least one processor, and the instructions are executed by the at least one processor to cause the at least one processor to execute the method according to the first aspect of the disclosure.

According to a third aspect of the disclosure, a non-transitory computer-readable storage medium for storing computer instructions non-transitory computer-readable storage medium for storing computer instructions is provided, in which the computer instructions are configured to cause the computer to execute the method according to the first aspect of the disclosure.

According to a fourth aspect of the disclosure, a computer program product is provided, including a computer program that, when executed by a processor, realizes the method according to the first aspect of the disclosure.

### BRIEF DESCRIPTION OF THE DRAWINGS

The accompanying drawings are used for a better understanding of the disclosure, and do not constitute a limitation of the disclosure.

FIG. 1 is a flow chart illustrating a method for processing an image according to Embodiment one of the disclosure.

FIG. 2 is a flow chart illustrating a method for processing an image according to Embodiment two of the disclosure.

FIG. 3 is a flow chart illustrating a method for processing an image according to Embodiment three of the disclosure.

FIG. 4 is a flow chart illustrating a method for processing an image according to Embodiment four of the disclosure.

FIG. 5 is a schematic diagram illustrating a training principle of a token extraction model according to an embodiment of the disclosure.

FIG. 6 is a flow chart illustrating a method for processing an image according to Embodiment five of the disclosure.

FIG. 7 is a schematic diagram illustrating a principle of image generation according to an embodiment of the disclosure.

FIG. 8 is a schematic diagram illustrating a principle of image understanding according to an embodiment of the disclosure.

FIG. 9 is a block diagram illustrating an apparatus for processing an image according to Embodiment six of the disclosure.

FIG. 10 is a block diagram illustrating an example electronic device configured to implement embodiments of the disclosure.

### DETAILED DESCRIPTION

Exemplary embodiments of the disclosure are described hereinafter in combination with the accompanying drawings, which include various details of embodiments of the disclosure in order to aid in understanding, and should be considered exemplary only. Accordingly, the ordinary skilled in the art should recognize that various changes and modifications can be made to the embodiments described herein without departing from the scope and spirit of the disclosure. Similarly, descriptions of well-known features and structures are omitted from the following description for the sake of clarity and brevity.

It should be noted that in the technical solutions of the disclosure, processing including collection, storage, use, shaping, transmission, provision and disclosure on personal information of a user is performed with the consent of the user, which is in compliance with the provisions of relevant laws and regulations, and does not violate public order and moral.

Transformer-based multimodal large-scale models achieve great success in image understanding and an image generation task. These models process both text and image inputs simultaneously, and output corresponding text or image responses based on user queries. Different from a method of directly obtaining a text token via a tokenizer, an external codec is usually relied to perform feature extraction and a quantization stage on image data to obtain a corresponding token sequence. In an encoding process of the image data, an original image is divided into multiple regions. After the regions are processed first via an encoder to obtain a vector matrix, the vector of each region is quantized into a discrete token. However, although the image token sequence obtained by such method performs well in the image generation task, such method may not achieve a good application in the image understanding.

For example, in an image encoding stage, the image is first divided into multiple regions. After the multiple regions are underwent an image encoding stage with a convolutional neural network (CNN) as a core architecture, an image feature representation corresponding to each region is obtained. Subsequently, the image feature representation undergoes a quantization stage to obtain an image token. However, such process usually only focuses on pixel features of the image and performs poorly in the image understanding, especially in forms and document understanding tasks. For such problem, a current processing method of a multimodal large-scale model is generally divided into two types. One is splitting the multimodal large-scale model directly two models, employing different encoders for the image generation and the image understanding respectively, in which the image generation employs an image encoder with a CNN as the core architecture, and the image understanding employs an image encoder with a transformer as the core architecture and focusing on semantic information modeling. The other type includes adding distillation of semantic information during training a CNN image encoder, such that the CNN image encoder has a certain degree of semantic perception capability.

Employing different encoders for the image generation and the image understanding essentially treats the image generation and the image understanding as two different modal tasks. Such method cannot achieve sufficient semantic understanding of the context image in a complex image generation task, thus performing poorly in tasks such as interlaced image-text data generation or semantic editing based on generated images. Adding the distillation of the semantic information during training the CNN image encoder may usually enhance the semantic perception capability of the image encoder to some certain extent. Although such method may achieve considerable performance improvement in an image question-answering task, this high-level semantic information is still qualified for the form and the document understanding task with character recognition as a core.

For at least one problem mentioned above, the disclosure proposes a method and apparatus for processing an image, an electronic device, and a storage medium.

Description is made below to the method and apparatus for processing the image, the electronic device, and the storage medium in embodiments of the disclosure with reference to the accompanying drawings.

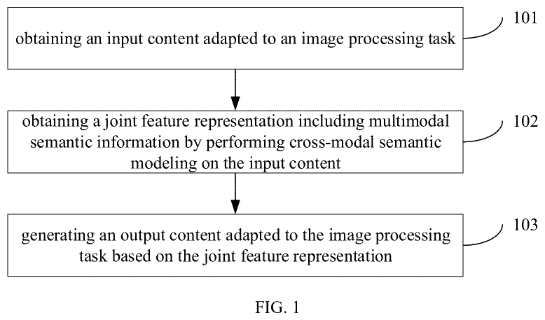

FIG. 1 is a flow chart illustrating a method for processing an image according to Embodiment one of the disclosure.

The method for processing the image is configured in the apparatus for processing the image as an example in embodiments of the disclosure. The apparatus for processing the image may be applied to any electronic device, such that the electronic device performs an image processing function.

The electronic device may be any device with a computing capability, such as, a computer, a mobile terminal, a server, or the like. The mobile terminal may be a hardware device with various operating systems, touch screens, and/or display screens such as, a vehicle-mounted device, a mobile phone, a tablet, a personal digital assistant, or a wearable device.

As illustrated in FIG. 1, the method for processing the image may include the following.

At block 101, an input content adapted to an image processing task is obtained.

The input content includes at least one of: a first text token sequence, a first image token sequence, or an image-text fusion sequence.

In embodiments of the disclosure, corresponding input data is obtained based on a specific image processing task (such as image understanding, image generating, image editing, etc.). The input content may include at least one of: the first text token sequence, the first image token sequence, and the image-text fusion sequence. The first text token sequence refers to text information for performing a linguistic description of the image content. For example, the input text is “a yellow dog is running on the grass”. The text is segmented into individual tokens to obtain the first text token sequence. The first image token sequence refers to a group of discretized representation units with both semantic and visual characteristics and extracted from an original input image. The first image token sequence is generated from a fused feature obtained by fusing a high-level semantic feature (such as meanings of objects, scenes, etc.) and a low-level pixel feature (such as details of color, texture, etc.) of the input image. For example, downsampling and quantization processing are sequentially performed on the fused feature to obtain the first image token sequence. The first image token sequence includes multiple image tokens, and each image token is a basic semantic unit that performs a structured and discretized representation of the image content, and is capable of effectively expressing local or global semantic information of the image. The image-text fusion sequence is generated by fusing the text token sequence of the input text and the image token sequence of the input image.

At block 102, a joint feature representation including multimodal semantic information is obtained by performing cross-modal semantic modeling on the input content

The multimodal semantic information indicates a semantic correlation relationship of the input content in different modalities.

To enable the model to understand a semantic relationship between different modalities, as a possible implementation, a self-attention mechanism or a cross-attention mechanism is employed to capture a semantic correlation of the input content across different modalities, thus generating the joint feature representation including the multimodal information. For example, when the input content includes a first image token sequence and a first text token sequence correspondingly describing “a cat is sleeping on a sofa”, a cross-modal attention mechanism identifies regions corresponding to “cat” and “sofa” in the image, and establishes a semantic correlation of the regions with corresponding words in the text, achieving alignment and fusion between the modalities.

At block 103, an output content adapted to the image processing task is generated based on the joint feature representation.

In embodiments of the disclosure, after a joint feature that integrates the multimodal semantic information is obtained, corresponding output content may be generated based on a requirement of the specific image processing task. For example, if the task is the image understanding task, the output content may be a natural language sentence. For another example, if the task is the image generating task, the output content may be a new image.

In conclusion, by obtaining the input content adapted to the image processing task, in which the input content includes at least one of: the first text token sequence, the first image token sequence, or the image-text fusion sequence, the flexibility and expressive capability of the form of the input content are effectively enhanced. Further, performing the cross-modal semantic modeling on the input content may deeply explore the semantic correlation relationship between different modalities, thus generating the joint feature representation including the multimodal semantic information. The joint feature not only preserves the inherent semantic structure of each modality but also effectively captures alignment, complementarity, and an interaction relationship between modalities, contributing to the construction of a unified semantic space, thus significantly improving the capability of the module in contextual understanding and cross-modal reasoning of the module. Finally, generating the output content adapted to the image processing task based on the joint feature representation ensures that the output result is highly consistent with the input content at a semantic level, further enhancing the accuracy and intelligence level of task execution.

To clearly illustrate how to obtain the joint feature representation including the multimodal semantic information by performing the cross-modal semantic modeling on the input content in the embodiments above, the disclosure provides another method for processing an image.

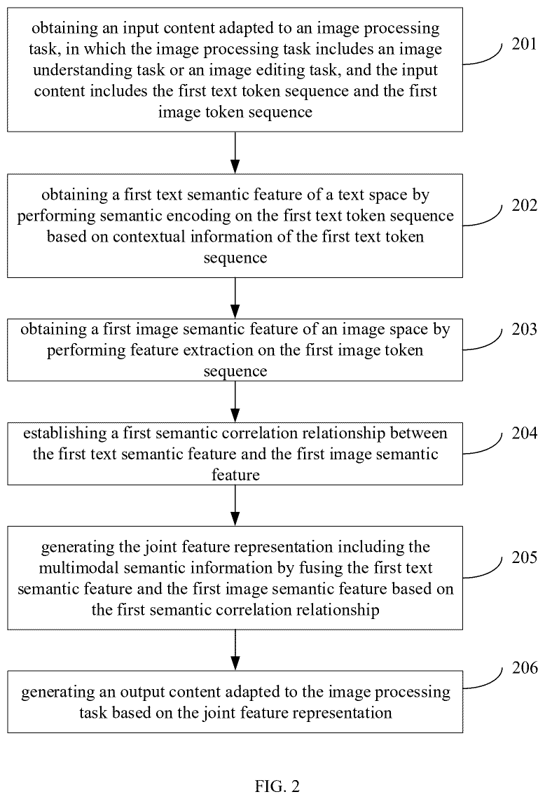

FIG. 2 is a flow chart illustrating a method for processing an image according to Embodiment two of the disclosure.

As illustrated in FIG. 2, the method for processing an image may include the following.

At block 201, an input content adapted to an image processing task is obtained, in which the image processing task includes an image understanding task or an image editing task, and the input content includes the first text token sequence and the first image token sequence.

As a possible implementation, when the image task is the image understanding task (such as image classification, visual question and answering) or the image editing task (such as image modification), the input content may include a first text token sequence and a first image token sequence, that is, the model may simultaneously receive and process input information from both a text and an image.

At block 202, a first text semantic feature of a text space is obtained by performing semantic encoding on the first text token sequence based on contextual information of the first text token sequence.

As a possible implementation, a semantic encoder (such as a text encoder in a Transformer) is employed to process the text token sequence, and to capture a semantic relationship and a contextual dependency between words to obtain a high-dimensional vector sequence, referred to as the first text semantic feature. The first text semantic feature represents the meaning of each token in a semantic space. For example, for a text “a cat is sleeping on a sofa”, a semantic relationship between keywords such as “cat”, “sofa”, and “sleeping” may be recognized.

At block 203, a first image semantic feature of an image space is obtained by performing feature extraction on the first image token sequence.

In embodiments of the disclosure, the first image token sequence is a group of basic semantic units with both semantic and visual characteristics and extracted from the image. Each token may be understood as an abstract representation of a meaningful region (such as an object, structure, etc.) in the image, reflecting a semantic meaning and a visual feature of the meaningful region. Further, the feature extraction is performed on the first image token sequence by a feature encoding network (such as an encoder or other feature enhancement modules in the Transformer), transforming the first image token sequence into a higher-dimensional semantic representation more suitable for cross-modal interaction. For example, a region in the input image corresponding to the first image token sequence is recognized as “cat”, and another region is recognized as “sofa”.

At block 204, a first semantic correlation relationship between the first text semantic feature and the first image semantic feature is established.

As a possible implementation, to enhance the capability of the module to understand and express complex semantics in the image processing task, semantic alignment is performed between the first text semantic feature and the first image semantic feature, to enable each token in the text to pay attention to the most relevant region in the image. For example, the token “cat” is semantically associated to the region in the image where the “cat” is located.

At block 205, the joint feature representation including the multimodal semantic information is generated by fusing the first text semantic feature and the first image semantic feature based on the first semantic correlation relationship.

Further, based on the first semantic correlation relationship, the joint feature representation is obtained by fusing the first text semantic feature and the first image semantic feature. The joint feature representation not only includes the semantic information of the first text semantic feature and the semantic information of the first image semantic feature, but also integrates the interaction and correlation between modalities.

At block 206, an output content adapted to the image processing task is generated based on the joint feature representation.

As a possible implementation, to improve the quality of image processing, the output content adapted to the image processing task is obtained by processing the joint feature representation employing an autoregressive mechanism.

As an example, in the case that the image processing task includes the image understanding task, a second text token sequence is obtained by performing multi-round iteration on the joint feature representation based on the autoregressive mechanism; and an image understanding text is generated based on the second text token sequence.

That is, to improve the quality of the image understanding and description, in the case that the image processing task to be executed currently is the image understanding task, for example, visual question and answering, image content summarization, image description, etc., a segment of natural language text needs to be output to express the understanding of the image content. Thus, in embodiments of the disclosure, each token in the image understanding text is generated step by step based on the already generated content, to obtain the second text token sequence. That is, taking the joint feature representation as the initial context, a text token sequence is generated by performing the multi-round iteration (i.e., predicting tokens step by step) on the joint feature representation. Finally, the tokens are concatenated or decoded into a natural language text, i.e., the image understanding text. The image understanding text may be an image description, an answer to a question, or any text expression related to the image content.

As another example, in the case that the image processing task includes the image editing task, an edited image token sequence is obtained by performing at least one round of editing on the first image token sequence based on the autoregressive mechanism and the joint feature representation; and a first target image is generated based on the edited image token sequence.

That is, to enhance the quality and automation level of image editing, in the case that the image processing task is the image editing task, the first image token sequence is edited sequentially based on the autoregressive mechanism and the joint feature representation that integrates original image information and an editing intent of the user, and the edited image token sequence is generated by adjusting image tokens one by one. Subsequently, based on the edited image token sequence, the corresponding complete image, i.e., the first target image, is generated by a pixel decoder, thus achieving semantic-level editing of the input image.

In conclusion, the first text semantic feature of the text space is obtained by performing the semantic encoding on the first text token sequence based on the contextual information of the first text token sequence. The first text semantic feature may effectively represent the linguistic semantic information included in the text. Simultaneously, the first image semantic feature of the image space is obtained by performing the feature extraction on the first image token sequence. The first image semantic feature preserves the spatial structure and the visual semantics of the image content. Further, to achieve an effective interaction of cross-modal information, the semantic correlation relationship between the first text semantic feature and the first image semantic feature is established, enabling dynamic identification and enhancement of strongly correlated parts across different modalities. In this way, the joint feature representation including the multimodal semantic information is generated by fusing the first text semantic feature and the first image semantic feature based on the semantic correlation relationship. The joint feature representation not only integrates the visual semantics of the image content, but also integrates the semantic intent of the text description, with a stronger expressive power and semantic integrity. A richer and more precise contextual support may be provided for a subsequent task (such as image understanding, image editing, etc.), and the understanding capability and execution accuracy for a complex image processing task is promoted.

To clearly illustrate how to obtain the joint feature representation including the multimodal semantic information by performing the cross-modal semantic modeling on the input content in the embodiments above, the disclosure provides another method for processing an image.

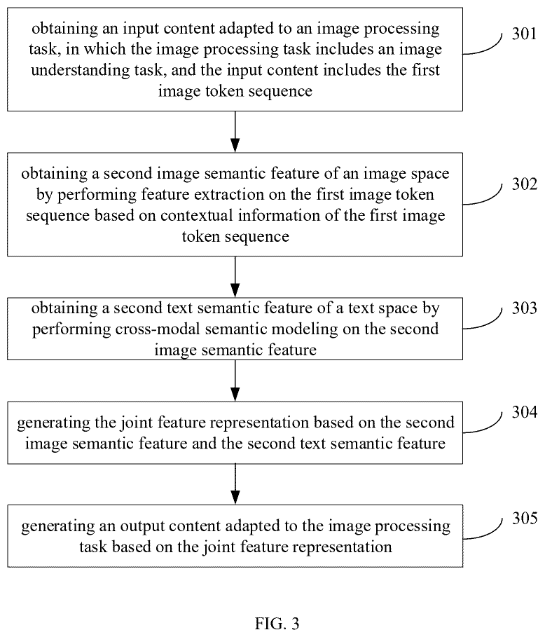

FIG. 3 is a flow chart illustrating a method for processing an image according to Embodiment three of the disclosure.

As illustrated in FIG. 3, the method for processing an image may include the following.

At block 301, an input content adapted to an image processing task is obtained, in which the image processing task includes an image understanding task, and the input content includes a first image token sequence.

As a possible implementation, when the image task is an image understanding task (such as image classification, visual question and answering), the input content may include a first image token sequence. The first image token sequence refers to a group of discretized representation units with both semantic and visual characteristics and extracted from an original input image. The first image token sequence is generated based on a fused feature obtained by fusing a high-level semantic feature (such as meanings of objects, scenes) and a low-level pixel feature (such as details of color, texture) of the image. For example, the first image token sequence is obtained by performing downsampling and quantization processing sequentially on the fused feature.

At block 302, a second image semantic feature of an image space is obtained by performing feature extraction on the first image token sequence based on contextual information of the first image token sequence.

As a possible implementation, to better characterize a spatial structure and semantic content of the image, context modeling (such as Transformer, or CNN) is utilized to extract a higher-level visual feature from the first image token sequence, thus obtaining the second image semantic feature of the image space.

At block 303, a second text semantic feature of a text space is obtained by performing cross-modal semantic modeling on the second image semantic feature.

In embodiments of the disclosure, to map image information into a text understandable form, the image feature may be mapped to the text semantic space, to generate the second text semantic feature that is semantically aligned with the image feature.

At block 304, the joint feature representation is generated based on the second image semantic feature and the second text semantic feature.

As a possible implementation, to enhance understanding and an expression capability of the model on a complex semantic, and to improve the generality of the model, the second image semantic feature and the second text semantic feature are fused to generate a unified feature vector including semantic information of both the second image semantic feature and the second text semantic feature, that is, the joint feature representation.

As another possible implementation, when the image processing task is the image understanding task, the input content may include an image-text fusion sequence. The image-text fusion sequence is obtained by fusing the text token sequence of the input text and the image token sequence of the input image. A third text semantic feature of the text space and a third image semantic feature of the image space are extracted from the image-text fusion sequence respectively; a second semantic correlation relationship is established between the third text semantic feature and the third image semantic feature; the joint feature representation including multimodal semantic information is generated by fusing the third text semantic feature and the third image semantic feature based on the second semantic correlation relationship.

That is, in the scenario where the image processing task is the image understanding task, the image-text fusion sequence may be taken as the input content. The image-text fusion sequence is a unified representation generated by performing cross-modal fusion processing on the text token sequence of the input text and the image token sequence of the input image. The image-text fusion sequence includes both the semantic information from the text and visual information from the image. Further, the third text semantic feature of the text space and the third image semantic feature of the image space are respectively extracted from the image-text fusion sequence to achieve fine-grained modeling of different modal information. The second semantic correlation relationship is established between the third text semantic feature and the third image semantic feature based on an attention mechanism or a semantic similarity calculation method, thus clarifying a correspondence and an interaction manner between the text description and the image content. Finally, the third text semantic feature and the third image semantic feature are fused based on the second semantic correlation relationship to generate the joint feature representation that may simultaneously reflect text semantics and image semantics, enhancing the expression capability of the multimodal semantics in the image understanding task, and the joint feature representation is used to support a subsequent image understanding task, such as image caption generation, image-text matching, visual question and answering.

At block 305, an output content adapted to the image processing task is generated based on the joint feature representation.

In conclusion, the input content adapted to the current image processing task is obtained, in which the input content includes the first image token sequence. The first image token sequence is the group of discretized visual units generated by processing the original input image via an encoder, which may effectively preserve the spatial structure and local detail information of the image. The second image semantic feature of the image space is obtained by performing the feature extraction on the first image token sequence based on the contextual information of the first image token sequence. Such process enhances the overall semantic perception capability of the image via the context modeling mechanisms, and may more accurately capture a relationship between objects, scene layout, and visual context information in the image. To further improve the language interpretability of the image content, the cross-modal semantic modeling is performed on the second image semantic feature, to map the second image semantic feature to the text semantic space, thus generating the second text semantic feature of the text space, achieving the conversion of the image information into natural language semantics, and providing basic support for subsequent image-text interaction. Further, the joint feature representation including the multimodal semantic information is generated based on the second image semantic feature and the second text semantic feature. The joint feature representation not only integrates the visual semantics of the image content, but also introduces abstract expression at the language level, with a stronger semantic expression capability and a contextual understanding capability.

To clearly illustrate how to generate the first image token sequence in the embodiments above, the disclosure provides another method for processing an image.

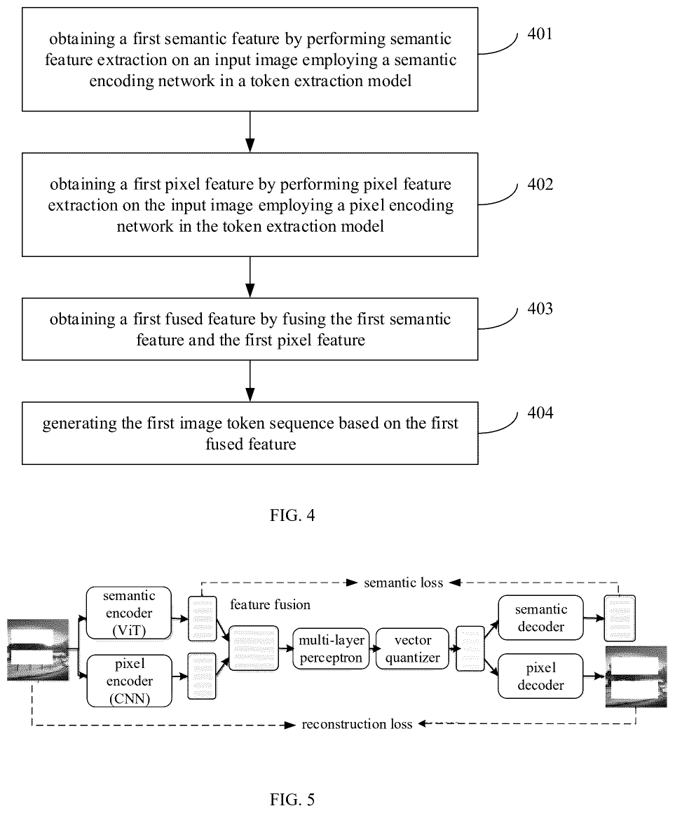

FIG. 4 is a flow chart illustrating a method for processing an image according to Embodiment four of the disclosure.

As illustrated in FIG. 4, the method for processing the image may include the following.

At block 401, a first semantic feature is obtained by performing semantic feature extraction on an input image employing a semantic encoding network in a token extraction model.

As a possible implementation, to accurately capture thematic content and key object information of the image, and to provide a semantically rich feature foundation for subsequent multimodal understanding and image tokenization processing, a semantic encoding network in the token extraction model is employed for performing the semantic feature extraction on high-level semantic information included in the input image. The semantic encoding network analyzes the image content and extracts a feature vector capable of representing a high-level concept such as an image theme and an object category, referred to as the first semantic feature.

It should be noted that the token extraction model is obtained by the following steps.

(1) A second semantic feature is obtained by performing semantic feature extraction on a sample image employing the semantic encoding network; and a second pixel feature is obtained by performing pixel feature extraction on the sample image employing the pixel encoding network.

In embodiments of the disclosure, the semantic encoding network (such as, a high-level semantic extractor based on a Transformer or CNN) is employed to extract high-level semantic information from the sample image, thus obtaining the second semantic feature. The second semantic feature indicates abstract semantic content such as the image theme, the object category, and the scene. Simultaneously, to preserve a local structure and a visual detail of the image (such as an edge, a color, a texture, and other detailed information), a pixel encoding network (such as a CNN structure) is employed to extract a low-level visual feature of the image, to obtain the second pixel feature.

(2) A restored semantic feature and a restored image are obtained by performing semantic restoration and image restoration on the sample image based on the second semantic feature and the second pixel feature.

As a possible implementation, to enhance a semantic consistency, a detail preserving capability, and an overall expression quality of the image token sequence, a feature fusion network, a semantic decoding network, and a pixel decoding network are introduced to enable the token extraction model to achieve bidirectional modeling and reconstruction of image content at both semantic and visual levels.

As an example, the token extraction model further includes: a feature fusion network, a semantic decoding network, and a pixel decoding network. A second fused feature is obtained by fusing the second semantic feature and the second pixel feature employing the feature fusion network; the restored semantic feature is obtained by performing the semantic restoration on the sample image employing the semantic decoding network based on the second fused feature; the restored image is obtained by performing the image restoration on the sample image employing the pixel decoding network based on the second fused feature.

That is, the token extraction model further includes: the feature fusion network, the semantic decoding network, and the pixel decoding network. The feature fusion network is configured to fuse a semantic feature and a pixel feature; the semantic decoding network is configured to restore semantic information from the fused feature; and the pixel decoding network is configured to restore the original image from the fused feature. The feature fusion network combines the second semantic feature and the second pixel feature to generate a unified feature representation, referred to as the second fused feature. The second fused feature includes both the thematic content of the image (such as “a dog is running on the grass”) and preserves the visual detail of the image (such as a color, a texture, a shape), thus providing a stronger representational capability for a subsequent task. Furthermore, the semantic decoding network is employed to reconstruct the semantic information of the original image from the fused feature, to obtain the restored semantic feature which is used to measure whether the model accurately captures the semantic content of the image. Simultaneously, the pixel decoding network is employed to reconstruct the sample image from the second fused feature, to obtain the restored image which is configured to evaluate whether the model has preserved sufficient visual detail information.

It should be noted that the token extraction model further includes: a multi-layer perceptron network and a quantization network. A second sampling feature is obtained by performing downsampling on the second fused feature employing the multi-layer perceptron network; a sample image token sequence is obtained by performing quantization processing on the second sampling feature employing the quantization network; the restored semantic feature is obtained by performing the semantic restoration on the sample image employing the semantic decoding network based on the sample image token sequence. Simultaneously, the restored image is obtained by reconstructing the sample image based on the sample image token sequence employing the pixel decoding network.

That is, the multi-layer perceptron network (MLP) is employed to perform the downsampling processing on the second fused feature to reduce the feature dimension and extract high-level semantic information, thus obtaining the second sampling feature. Subsequently, the quantization network is employed to perform discretization processing on the second sampling feature, mapping the second sampling feature to a discrete token space to generate the sample image token sequence, achieving a compact representation of the image content. Finally, the semantic decoding network is employed to reconstruct the semantic information of the image based on the image token sequence, to output a corresponding restored semantic feature which is configured to evaluate the semantic retention capability of the model. In this way, by introducing the multi-layer perceptron network for the feature downsampling, the spatial dimension of the image features is effectively compressed, and a computational efficiency is improved. Meanwhile, with the help of the quantization network, a continuous feature is converted into a discrete image token sequence, achieving efficient encoding and semantic abstraction of the image content. Further, performing the semantic restoration on the sample token sequence by the semantic decoding network may verify whether the extracted tokens preserve sufficient semantic information, and the image restoration on the sample token sequence by the pixel decoding network may evaluate whether the model preserves sufficient visual detail information.

(3) The token extraction model is trained based on a difference between the restored semantic feature and the second semantic feature and a difference between the restored image and the sample image.

As a possible implementation, to enhance an understanding capability of the model on high-level semantics of the image and a restoring capability of the model on a low-level visual detail, the token extraction model is jointly trained by combining a semantic restoration loss and an image restoration loss.

As an example, a first loss function value is generated based on the difference between the restored semantic feature and the second semantic feature; a second loss function value is generated based on the difference between the restored image and the sample image; and the token extraction model is trained based on the first loss function value and the second loss function value.

For example, the semantic encoding network in the token extraction model is trained based on the first loss function value; and the semantic encoding network is kept, and other network in the token extraction model than the semantic encoding network is trained based on the second loss function value to obtain the token extraction model subjected to training.

That is, as a possible implementation, to improve the stability and efficiency of model training and to enhance the semantic accuracy and visual authenticity of the image token sequence generated finally, a phased training strategy is employed to gradually optimize other components of the token extraction model under the premise of ensuring the quality of semantic encoding.

As an example, the semantic encoding network may be trained based on the first loss function value generated by the difference between the restored semantic feature and the second semantic feature. After preliminary training on the semantic encoding network is completed, parameters of the semantic encoding network are kept (no longer updated). The second loss function value generated based on the difference between the reconstructed image and the sample image (usually from the image reconstruction task) is employed to train remaining parts of the token extraction model, in which the remaining parts include the pixel encoding network, the feature fusion network, the decoding network, etc., ensuring that subsequent network modules may better adapt to a stabilized semantic feature while focusing on the modeling and reconstruction of the image detail.

For example, as illustrated in FIG. 5, the token extraction model includes two branches. One branch is a semantic branch based on a vision Transformer (ViT), and the other branch is a pixel branch based on the CNN. The features of the semantic branch and the pixel branch are fused and then quantization operation is performed on the fused feature. Based on the quantized feature, a pixel decoder performs the image restoration and calculates the reconstruction loss between the restored image and the original image (sample image). Simultaneously, a semantic decoder also performs the semantic restoration on the quantized feature, and a semantic restoration loss between the restored feature and the ViT output is calculated. The training process includes two parts: (1) independently pre-training the VIT; and (2) keeping ViT and training the remaining components.

With this solution, the token extraction model is jointly trained by combining the semantic restoration loss and the image restoration loss, which may simultaneously enhance the understanding capability of the model on the high-level semantics of the image and the restoring capability of the model on the low-level visual detail, thus generating an image token sequence with a semantic consistency and a clear structure.

At block 402, a first pixel feature is obtained by performing pixel feature extraction on the input image employing a pixel encoding network in the token extraction model.

As a possible implementation, to further improve a fine structure expression of the image and to provide a basic support for subsequent feature fusion, the low-level visual feature of the image is extracted by employing the pixel encoding network.

As an example, the pixel encoding network in the token extraction model is employed to extract the low-level visual feature, such as the edge, the color, and the texture, from an original pixel value of the input image. These low-level visual features help to preserve detail information of the image which is referred to as the first pixel feature.

At block 403, a first fused feature is obtained by fusing the first semantic feature and the first pixel feature.

In embodiments of the disclosure, to create a comprehensive feature representation that may reflect both the macroscopic meaning and microscopic details of the image, the first fused feature is obtained by fusing the first semantic feature and the first pixel feature. The fusing may be achieved in various ways, such as a simple concatenation operation or a more complex interactive fusion method.

At block 404, the first image token sequence is generated based on the first fused feature.

As a possible implementation, to improve the image understanding capability, the fused feature obtained above is employed and transformed into a series of discrete tokens. The image tokens may be regarded as a new form of image expression. Each image token represents an abstract semantic representation of a local region in the image, and the entire image token sequence constitutes a structured and semantic high-level summary of the entire image content. This expression not only preserves the key visual and semantic information of the image, but also possesses compactness and modelability, which is suitable for a multimodal task such as image generation and image-text fusion modeling. That is, the first image token sequence may be used in the method for processing the image of any of the above embodiments.

As a possible implementation, to further achieve efficient discrete modeling of the image content, dimension reduction processing is performed on the fused feature by a multi-layer perceptron network, and the fused feature is mapped into a discrete image token sequence in combination with a quantization network.

As an example, a first sampling feature is obtained by performing downsampling on the first fused feature employing the multi-layer perceptron network in the token extraction model; and the first image token sequence is generated by performing quantization processing on the first sampling feature employing the quantization network in the token extraction model.

That is, the multi-layer perceptron (MLP) network is employed to perform the downsampling processing on the first fused feature to compress feature dimension of the first fused feature, thus obtaining the first sampling feature. Such process significantly enhances the compactness and computational efficiency of the feature representation on the premise of preserving the key semantics and visual information in the original fused feature. Subsequently, the quantization network is employed to map continuous value vectors in the first sampling feature to a group of predefined discrete codebook spaces. In detail, each sampling feature is replaced by a closest vector of the sampling feature in the codebook, and the corresponding index value is recorded. The index value is the image token. Thus, multiple image tokens are arranged in sequence to form the first image token sequence.

In conclusion, the semantic feature extraction is performed on the input image by employing the semantic encoding network in the token extraction model to obtain the first semantic feature. The first semantic feature may effectively represent the high-level semantic information such as the thematic content, the object category, and the scene information of the image. Further, the pixel feature extraction is performed on the input image by employing the pixel encoding network in the token extraction model to obtain the first pixel feature. The first pixel feature preserves the low-level visual detail such as the edge, the color, and the texture of the image, which helps improve the accuracy of the image reconstruction and understanding. The first fused feature including the multi-level information is generated by fusing the first semantic feature and the first pixel feature. The fused feature not only inherits the high-level semantic expression of the image, but also preserves key visual detail information, with a stronger expressive capability and a contextual awareness capability. Finally, the first image token sequence for subsequent image understanding or editing tasks is generated based on the first fused feature. The token sequence maintains the image semantic consistency and also has a good structural integrity and visual authenticity, and may be widely used in the image processing task of a Transformer-based architecture.

To clearly illustrate how to obtain the joint feature representation including the multimodal semantic information by performing the cross-modal semantic modeling on the input content in the embodiments above, the disclosure provides another method for processing an image.

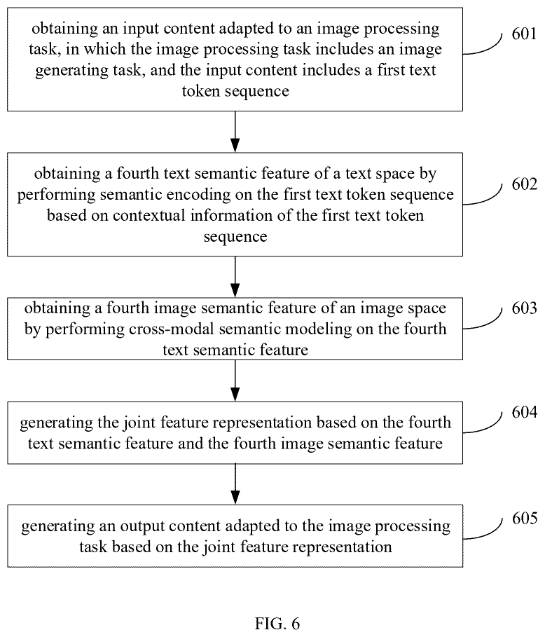

FIG. 6 is a flow chart illustrating a method for processing an image according to Embodiment five of the disclosure.

As illustrated in FIG. 6, the method for processing an image may include the following.

At block 601, an input content adapted to an image processing task is obtained, in which the image processing task includes an image generating task, and the input content includes a first text token sequence.

In embodiments of the disclosure, when the current image processing task is the image generating task, the input content is the first text token sequence, that is, a text description or instruction of the image to be generated provided by a user.

At block 602, a fourth text semantic feature of a text space is obtained by performing semantic encoding on the first text token sequence based on contextual information of the first text token sequence.

As a possible implementation, to accurately capture a user intent and enhance the controllability of image generation, a semantic encoder (such as Transformer, BERT) is employed to analyze a semantic relationship between text tokens, to extract a high-dimensional vector representation which referred to as the fourth text semantic feature, and the high-dimensional vector representation is used to characterize the deep linguistic semantics of the text corresponding to the first text token sequence.

At block 603, a fourth image semantic feature of an image space is obtained by performing cross-modal semantic modeling on the fourth text semantic feature.

In embodiments of the disclosure, to achieve image-text semantic alignment and improve generation consistency, the fourth image semantic feature is obtained by mapping the text semantic feature to the image semantic space, that is, a visual semantic representation that may be used for image generation.

At block 604, the joint feature representation is generated based on the fourth text semantic feature and the fourth image semantic feature.

In embodiments of the disclosure, to further enhance the image semantic expression capability, the text semantic feature and the image semantic feature are fused to form a unified joint feature representation. The joint feature representation has both the abstractness of language description and the concreteness of image structure, serving as a driving factor for subsequent image generation.

At block 605, an output content adapted to the image processing task is generated based on the joint feature representation.

In embodiments of the disclosure, to improve the generation quality of the image and the semantic consistency of the input text, the joint feature is converted into a pixel image.

As an example, a second image token sequence corresponding to at least one resolution is obtained by performing multi-round iteration on the joint feature representation based on an autoregressive mechanism; and a second target image is generated based on the second image token sequence corresponding to the at least one resolution.

That is, to improve the quality of the image generation, the joint feature representation is gradually refined through an autoregressive manner to generate image token sequences (i.e., the second image token sequence) at different resolutions. Each round of iteration is further optimized based on the results of the previous round, ensuring that the final generated image not only meets the requirement of the input content, but also has a high quality and detail.

During generating the second target image based on the second image token sequence corresponding to the at least one resolution, for any second image token sequence, a semantic level of the second image token sequence is determined based on a semantic feature of the second image token sequence; a third image token sequence is obtained by performing upsampling on the second image token sequence based on the semantic level; and the second target image is obtained by fusing respective third image token sequences.

That is, to improve the quality of the image generation, a type or theme of information (i.e., the semantic feature) included in each second image token sequence is evaluated based on the semantic feature of the second image token sequence, and the information is classified into different semantic levels based on the importance or abstraction degree of the information. For example, a low level may include a basic color and shape, and a high level involves a detailed object or scene. Based on a determined semantic level, enlarged processing (i.e., upsampling) is performed on each second image token sequence to increase a resolution and details of the second image token sequence, thus obtaining a new and clearer image part (i.e., the third image token sequence). The final step is merging all upsampled image parts (i.e., fusion) to form a complete, high-resolution second target image.

In conclusion, by analyzing the contextual information in the first text token sequence, the semantic encoding is performed on the first text token sequence to convert the first text token sequence into the fourth text semantic feature that may be expressed in the text space. Such process effectively captures the core semantics and key details in the text information, ensuring accurate understanding of the user intent. Further, the corresponding fourth image semantic feature is generated by further mapping the fourth text semantic feature to the image space, thus achieving effective transformation from text description to image semantics, and providing feasibility for subsequent deep integration of image-text information. Furthermore, a comprehensive joint feature representation is generated based on the extracted text semantic feature and the extracted image semantic feature. The joint feature representation not only completely preserves the key semantic information of the original text, but also integrates the visual structure and the style feature required by the image, and providing a unified and semantical consistent representational basis for high-quality image generation. Finally, the output content adapted to the image processing task is generated based on the joint feature representation. The generated image may accurately reflect the description content of the input text and simultaneously achieve a high standard in the visual quality, detail representation, and overall composition, significantly improving the accuracy of the image generation task and the user experience.

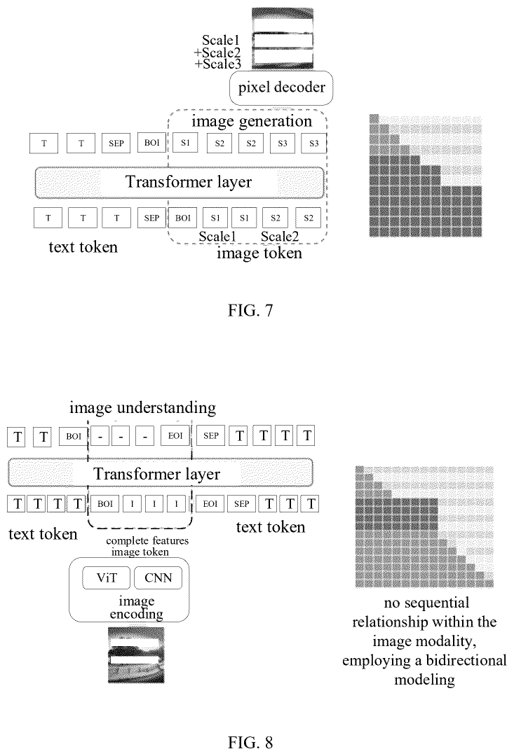

For example, as illustrated in FIG. 7, taking the image processing task as an image generating task as an example, the method for processing an image according to an embodiment of the disclosure may include the following steps.

(1) A user inputs a segment of text (such as “TTT”), the text is converted into a series of text tokens, that is, a first text token sequence.

(2) The text tokens are processed by a Transformer layer. The Transformer layer captures contextual information and core meaning in the text, performs semantic encoding on the text tokens to obtain a third text semantic feature. The third text semantic feature is input into an image decoder, and the image decoder converts the text features into image features, achieving cross-modal semantic modeling from the text space to the image space, thus obtaining a third image semantic feature of the image space.

(3) Based on the fourth text semantic feature and the fourth image semantic feature, the system generates a comprehensive joint feature representation. The joint feature not only includes all key information of the original text, but also integrates a visual characteristic that the target image should have.

(4) A second image token sequence corresponding to multiple resolutions (such as Scale1, Scale2, and Scale3) is obtained by performing multi-round iteration on the joint feature representation based on an autoregressive mechanism.

(5) Image restoration is performed on the second image token sequence corresponding to the multiple resolutions by employing a pixel decoder of the trained token extraction model, to generate a second target image.

For example, as illustrated in FIG. 8, taking an image processing task as an image understanding task as an example, the method for processing an image may include the following steps.

### (1) Text Input and Encoding

A user inputs a segment of text (such as “TTT”), the text is converted into a series of text tokens, that is, a first text token sequence. The first text token sequence is processed via a Transformer layer. The Transformer layer performs semantic encoding on the first text token sequence, to capture contextual information and core meaning in the text, thus obtaining a first text semantic feature.

(2) An image is inputted, and the image is converted into an image token sequence, that is, a first image token sequence, by employing a ViT and CNN in the trained token extraction model. The first image token sequence is also processed via the Transformer layer to extract feature information of the image, thus obtaining a first image semantic feature;

(3) The text tokens and the image tokens are inputted together into the Transformer layer for joint modeling. It should be noted that, since there is no sequential relationship within the image modality, a bidirectional modeling approach is employed to enable the model to better capture the correlation between the image and the text. In the Transformer layer, the first text token sequence and the first image token sequence interact with each other to generate a joint feature representation that integrates text and image information;

(4) Operations such as recognition and understanding on the image are performed based on the joint feature representation, to output text content that understands and interprets the image.

Corresponding to the method for processing the image according to the embodiments of FIG. 1 to FIG. 8, the disclosure also provides an apparatus for processing an image. Since the apparatus for processing the image according to embodiments of the disclosure corresponds to the method according to the embodiments of FIG. 1 to FIG. 8, the implementation of the method for processing the image is also applicable to the apparatus for processing the image according to embodiments of the disclosure, which is not described in detail in the following embodiments.

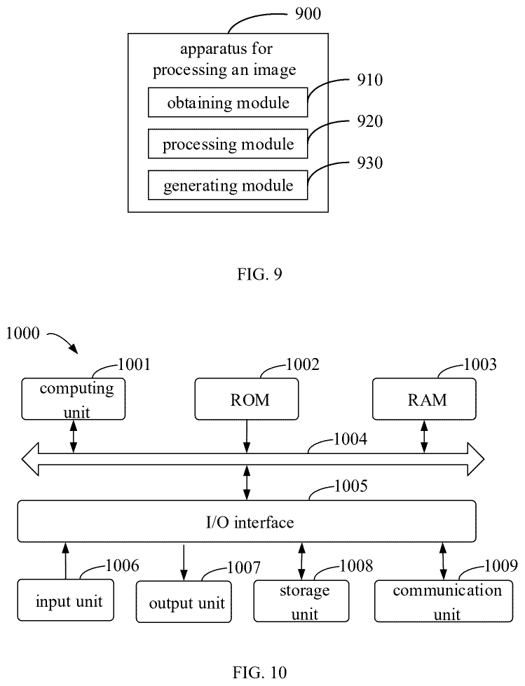

FIG. 9 is a block diagram illustrating an apparatus for processing an image according to Embodiment six of the disclosure.

As illustrated in FIG. 9, the apparatus for processing the image includes an obtaining module 910, a processing module 920 and a generating module 930.

The obtaining module 910 is configured to obtain an input content adapted to an image processing task, in which the input content includes at least one of: a first text token sequence, a first image token sequence, or an image-text fusion sequence. The processing module 920 is configured to obtain a joint feature representation including multimodal semantic information by performing cross-modal semantic modeling on the input content, in which the multimodal semantic information indicates a semantic correlation relationship of the input content in different modalities. The generating module 930 is configured to generate an output content adapted to the image processing task based on the joint feature representation.

As a possible implementation, the image processing task includes an image understanding task or an image editing task, and the input content includes the first text token sequence and the first image token sequence. The processing module 920 is configured to obtain a first text semantic feature of a text space by performing semantic encoding on the first text token sequence based on contextual information of the first text token sequence; obtain a first image semantic feature of an image space by performing feature extraction on the first image token sequence; establish a first semantic correlation relationship between the first text semantic feature and the first image semantic feature; and generate the joint feature representation including the multimodal semantic information by fusing the first text semantic feature and the first image semantic feature based on the first semantic correlation relationship.

As a possible implementation, the generating module 930 is configured to, in the case that the image processing task includes the image understanding task, obtain a second text token sequence by performing multi-round iteration on the joint feature representation based on an autoregressive mechanism; and generate an image understanding text based on the second text token sequence.

As a possible implementation, the generating module 930 is configured to, in the case that the image processing task includes the image editing task, obtain an edited image token sequence by performing at least one round of editing on the first image token sequence based on an autoregressive mechanism and the joint feature representation; and generate a first target image based on the edited image token sequence.

As a possible implementation, the image processing task includes an image understanding task, and the input content includes the first image token sequence. The processing module 920 is configured to obtain a second image semantic feature of an image space by performing feature extraction on the first image token sequence based on contextual information of the first image token sequence; obtain a second text semantic feature of a text space by performing cross-modal semantic modeling on the second image semantic feature; and generate the joint feature representation based on the second image semantic feature and the second text semantic feature.

As a possible implementation, the first image token sequence is obtained via a first extracting module, a fusing module and a determining module.

The first extracting module is configured to obtain a first semantic feature by performing semantic feature extraction on an input image employing a semantic encoding network in a token extraction model; and obtain a first pixel feature by performing pixel feature extraction on the input image employing a pixel encoding network in the token extraction model. The fusing module is configured to obtain a first fused feature by fusing the first semantic feature and the first pixel feature. The determining module is configured to generate the first image token sequence based on the first fused feature.

As a possible implementation, the determining module is configured to obtain a first sampling feature by performing downsampling on the first fused feature employing a multi-layer perceptron network in the token extraction model; and generate the first image token sequence by performing quantization processing on the first sampling feature employing a quantization network in the token extraction model.

As a possible implementation, the token extraction model is obtained via a second extracting module, a restoring module and a training module.

The second extracting module is configured to obtain a second semantic feature by performing semantic feature extraction on a sample image employing the semantic encoding network; and obtain a second pixel feature by performing pixel feature extraction on the sample image employing the pixel encoding network. The restoring module is configured to obtain a restored semantic feature and a restored image by performing semantic restoration and image restoration on the sample image based on the second semantic feature and the second pixel feature. The training module is configured to train the token extraction model based on a difference between the restored semantic feature and the second semantic feature and a difference between the restored image and the sample image.

As a possible implementation, the training module is configured to generate a first loss function value based on the difference between the restored semantic feature and the second semantic feature; generate a second loss function value based on the difference between the restored image and the sample image; and train the token extraction model based on the first loss function value and the second loss function value.

As a possible implementation, the training module is configured to train the semantic encoding network in an image processing model based on the first loss function value; and keep the semantic encoding network, and obtain the token extraction model subjected to training by training other network in the token extraction model than the semantic encoding network based on the second loss function value.

As a possible implementation, the token extraction model further includes: a feature fusion network, a semantic decoding network, and a pixel decoding network. The restoring module is configured to obtain a second fused feature by fusing the second semantic feature and the second pixel feature employing the feature fusion network; obtain the restored semantic feature by performing the semantic restoration on the sample image employing the semantic decoding network based on the second fused feature; and obtain the restored image by performing the image restoration on the sample image employing the pixel decoding network based on the second fused feature.

As a possible implementation, the token extraction model further includes: a multi-layer perceptron network and a quantization network. The restoring module is configured to obtain a second sampling feature by performing downsampling on the second fused feature employing the multi-layer perceptron network; obtain a sample image token sequence by performing quantization processing on the second sampling feature employing the quantization network; and obtain the restored semantic feature by performing the semantic restoration on the sample image employing the semantic decoding network based on the sample image token sequence.

As a possible implementation, the image processing task includes an image generating task or an image editing task and the input content includes the image-text fusion sequence. The processing module 920 is configured to extract a third text semantic feature of a text space and a third image semantic feature of an image space from the image-text fusion sequence respectively; establish a second semantic correlation relationship between the third text semantic feature and the third image semantic feature; and generate the joint feature representation including the multimodal semantic information by fusing the third text semantic feature and the third image semantic feature based on the second semantic correlation relationship.

As a possible implementation, the image processing task includes an image generating task, and the input content includes the first text token sequence. The processing module 920 is configured to obtain a fourth text semantic feature of a text space by performing semantic encoding on the first text token sequence based on contextual information of the first text token sequence; obtain a fourth image semantic feature of an image space by performing cross-modal semantic modeling on the fourth text semantic feature; and generate the joint feature representation based on the fourth text semantic feature and the fourth image semantic feature.

As a possible implementation, the generating module 930 is configured to obtain a second image token sequence corresponding to at least one resolution by performing multi-round iteration on the joint feature representation based on an autoregressive mechanism; and generate a second target image based on the second image token sequence corresponding to the at least one resolution.

As a possible implementation, the generating module 930 is configured to, for any second image token sequence, determine a semantic level of the second image token sequence based on a semantic feature of the second image token sequence; obtain a third image token sequence by performing upsampling on the second image token sequence based on the semantic level; and obtain the second target image by fusing respective third image token sequences.

With the apparatus for processing the image according to the embodiments of the disclosure, by obtaining the input content adapted to the image processing task, in which the input content includes at least one of: the first text token sequence, the first image token sequence, or the image-text fusion sequence, the flexibility and expressive capability of the form of the input content are effectively enhanced. Further, performing the cross-modal semantic modeling on the input content may deeply explore the semantic correlation relationship between different modalities, thus generating the joint feature representation including the multimodal semantic information. The joint feature not only preserves the inherent semantic structure of each modality, but also effectively captures alignment, complementarity, and interaction relationships between modalities, contributing to the construction of a unified semantic space, thus significantly improving the capability of the module in contextual understanding and cross-modal reasoning of the module. Finally, generating the output content adapted to the image processing task based on the joint feature representation ensures that the output result is highly consistent with the input content at the semantic level, further enhancing the accuracy and intelligence level of task execution.

To achieve the above embodiments, the disclosure also provides an electronic device. The electronic device includes at least one processor; and a memory communicatively coupled to the at least one processor. The memory stores instructions executable by the at least one processor; in which when the instructions are executed by the at least one processor, the at least one processor is caused to perform the method for processing the image according to any of the above embodiments of the disclosure.

To achieve the above embodiments, the disclosure provides a non-transitory computer readable storage medium for storing computer instructions. The computer instructions are configured to enable a computer to perform the method for processing the image according to any of the above embodiments of the disclosure.

To achieve the above embodiments, the disclosure provides a computer program product. The computer program product includes a computer program. The computer program realizes the method for processing the image according to any of the above embodiments of the disclosure when executed by a processor.

According to embodiments of the disclosure, the disclosure also provides an electronic device, a readable storage medium, and a computer program product.

Referring to FIG. 10, FIG. 10 is a block diagram illustrating an example electronic device configured to implement embodiments of the disclosure. The electronic device is intended to represent various types of digital computers, such as a laptop computer, a desktop computer, a workstation, a personal digital assistant, a server, a blade server, a mainframe computer, and other suitable computers. The electronic device may also represent various types of mobile devices, such as a personal digital assistant, a cellular phone, a smart phone, a wearable device, and other similar computing devices. The components illustrated herein, their connections and relations, and their functions are merely examples, which are not intended to limit the implementations of the disclosure described and/or required herein.

As illustrated in FIG. 10, the electronic device 1000 includes a computing unit 1001, configured to execute various appropriate actions and processes according to a computer program stored in a read-only memory (ROM) 1002 or a computer program loaded from a storage unit 1008 to a random access memory (RAM) 1003. In the RAM 1003, various programs and data required for the device 1000 may be stored. The computing unit 1001, the ROM 1002 and the RAM 1003 may be connected with each other by a bus 1004. An input/output (I/O) interface 1005 is also connected to the bus 1004. The multiple components in the electronic device 1000 are connected to the I/O interface 1005, which include: an input unit 1006, such as, a keyboard, a mouse; an output unit 1007, such as, various types of displays, speakers; a storage unit 1008, such as, a magnetic disk, an optical disk; and a communication unit 1009, such as, a network card, a modem, a wireless transceiver. The communication unit 1009 allows the electronic device 1000 to exchange information/data through a computer network such as Internet and/or various types of telecommunication networks with other devices.

The computing unit 1001 may be various types of general and/or dedicated processing components with processing and computing capabilities. Some examples of a computing unit 1001 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 1001 executes various methods and processes as described above, for example, the method for processing the image. For example, in some embodiments, the method for processing the image may be further implemented as a computer software program, which is tangibly included in a machine readable medium, such as the storage unit 1008. In some embodiments, a part or all of the computer program may be loaded and/or installed on the electronic device 1000 via the ROM 1002 and/or the communication unit 1009. When the computer program is loaded on the RAM 1003 and executed by the computing unit 1001, one or more steps in the method for processing the image may be performed as described above. Alternatively, in other embodiments, the computing unit 1001 may be configured to the method for processing the image in other appropriate ways (for example, by virtue of a firmware).

Various implementations of the systems and techniques described above may be implemented by a digital electronic circuit system, an integrated circuit system, field programmable gate arrays (FPGAs), application specific integrated circuits (ASICs), application specific standard products (ASSPs), system on chip (SOCs), load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor. The programmable processor may be a dedicated or general programmable processor for receiving data and instructions from the storage system, at least one input device and at least one output device, and transmitting the data and instructions to the storage system, the at least one input device and the at least one output device.

The program codes configured to implement the method of the disclosure may be written in any combination of one or more programming languages. These program codes may be provided for the processors or controllers of general-purpose computers, dedicated computers, or other programmable data processing devices, such that the program codes, when executed by the processors or controllers, enable the functions/operations specified in the flowchart and/or block diagram to be implemented. The program codes may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may include or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMS, ROMs, electrically programmable read-only-memory (EPROM), fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a local area network (LAN), a wide area network (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, also known as a cloud computing server or a cloud host, which is a host product in a cloud computing service system, to solve difficult management and weak business scalability in conventional physical host and VPS (virtual private server) services.

It should be noted that AI is a discipline that studies enabling computers to simulate certain human thought processes and intelligent behaviors (such as learning, reasoning, thinking, planning, etc.), encompassing technologies at both the hardware level and the software level. AI hardware technologies generally include technologies such as sensors, dedicated AI chips, cloud computing, distributed storage, and big data processing. The AI software technologies primarily include several major domains: computer vision technology, speech recognition technology, natural language processing technology, and machine learning/deep learning, big data processing technology, and knowledge graph technology.

According to the technical solution in the embodiments of the disclosure, by obtaining the input content adapted to the image processing task, in which the input content includes at least one of: the first text token sequence, the first image token sequence, or the image-text fusion sequence, the flexibility and expressive capability of the form of the input content are effectively enhanced. Further, performing the cross-modal semantic modeling on the input content may deeply explore the semantic correlation relationship between different modalities, thus generating the joint feature representation including the multimodal semantic information. The joint feature representation not only preserves the inherent semantic structure of each modality, but also effectively captures alignment, complementarity, and interaction relationships between modalities, contributing to the construction of the unified semantic space, thus significantly improving the capability of the module in contextual understanding and cross-modal reasoning of the module. Finally, generating the output content adapted to the image processing task based on the joint feature representation ensures that the output result is highly consistent with the input content at the semantic level, further enhancing the accuracy and intelligence level of task execution.

It should be understood that the various forms of processes illustrated above can be used to reorder, add or delete steps. For example, the steps described in the disclosure could be performed in parallel, sequentially, or in different orders, as long as the desired result of the technical solution disclosed in the disclosure is achieved, which is not limited herein.

The above detailed implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for processing an image, comprising:
obtaining an input content adapted to an image processing task, wherein the input content comprises at least one of: a first text token sequence, a first image token sequence, or an image-text fusion sequence;
obtaining a joint feature representation comprising multimodal semantic information by performing cross-modal semantic modeling on the input content, wherein the multimodal semantic information indicates a semantic correlation relationship of the input content in different modalities; and
generating an output content adapted to the image processing task based on the joint feature representation.

2. The method of claim 1, wherein the image processing task comprises an image understanding task or an image editing task, and the input content comprises the first text token sequence and the first image token sequence; and
obtaining the joint feature representation comprising the multimodal semantic information by performing the cross-modal semantic modeling on the input content comprises:
obtaining a first text semantic feature of a text space by performing semantic encoding on the first text token sequence based on contextual information of the first text token sequence;
obtaining a first image semantic feature of an image space by performing feature extraction on the first image token sequence;
establishing a first semantic correlation relationship between the first text semantic feature and the first image semantic feature; and
generating the joint feature representation comprising the multimodal semantic information by fusing the first text semantic feature and the first image semantic feature based on the first semantic correlation relationship.

3. The method of claim 2, wherein generating the output content adapted to the image processing task based on the joint feature representation comprises:
in the case that the image processing task comprises the image understanding task, obtaining a second text token sequence by performing multi-round iteration on the joint feature representation based on an autoregressive mechanism; and
generating an image understanding text based on the second text token sequence.

4. The method of claim 2, wherein generating the output content adapted to the image processing task based on the joint feature representation comprises:
in the case that the image processing task comprises the image editing task, obtaining an edited image token sequence by performing at least one round of editing on the first image token sequence based on an autoregressive mechanism and the joint feature representation; and
generating a first target image based on the edited image token sequence.

5. The method of claim 1, wherein the image processing task comprises an image understanding task, and the input content comprises the first image token sequence; and
obtaining the joint feature representation comprising the multimodal semantic information by performing the cross-modal semantic modeling on the input content comprises:
obtaining a second image semantic feature of an image space by performing feature extraction on the first image token sequence based on contextual information of the first image token sequence;
obtaining a second text semantic feature of a text space by performing cross-modal semantic modeling on the second image semantic feature; and
generating the joint feature representation based on the second image semantic feature and the second text semantic feature.

6. The method of claim 1, wherein the first image token sequence is obtained by:
obtaining a first semantic feature by performing semantic feature extraction on an input image employing a semantic encoding network in a token extraction model;
obtaining a first pixel feature by performing pixel feature extraction on the input image employing a pixel encoding network in the token extraction model;
obtaining a first fused feature by fusing the first semantic feature and the first pixel feature; and
generating the first image token sequence based on the first fused feature.

7. The method of claim 6, wherein generating the first image token sequence based on the first fused feature comprises:
obtaining a first sampling feature by performing downsampling on the first fused feature employing a multi-layer perceptron network in the token extraction model; and
generating the first image token sequence by performing quantization processing on the first sampling feature employing a quantization network in the token extraction model.

8. The method of claim 6, wherein the token extraction model is obtained by:
obtaining a second semantic feature by performing semantic feature extraction on a sample image employing the semantic encoding network; and obtaining a second pixel feature by performing pixel feature extraction on the sample image employing the pixel encoding network;
obtaining a restored semantic feature and a restored image by performing semantic restoration and image restoration on the sample image based on the second semantic feature and the second pixel feature; and
training the token extraction model based on a difference between the restored semantic feature and the second semantic feature and a difference between the restored image and the sample image.

9. The method of claim 8, wherein training the token extraction model based on the difference between the restored semantic feature and the second semantic feature and the difference between the restored image and the sample image comprises:
generating a first loss function value based on the difference between the restored semantic feature and the second semantic feature;
generating a second loss function value based on the difference between the restored image and the sample image; and
training the token extraction model based on the first loss function value and the second loss function value.

10. The method of claim 9, wherein training the token extraction model based on the first loss function value and the second loss function value comprises:
training the semantic encoding network in the token extraction model based on the first loss function value; and
keeping the semantic encoding network, and obtaining the token extraction model subjected to training by training other network in the token extraction model than the semantic encoding network based on the second loss function value.

11. The method of claim 8, wherein the token extraction model further comprises: a feature fusion network, a semantic decoding network, and a pixel decoding network, and
obtaining the restored semantic feature and the restored image by performing the semantic restoration and the image restoration on the sample image based on the second semantic feature and the second pixel feature comprises:
obtaining a second fused feature by fusing the second semantic feature and the second pixel feature employing the feature fusion network;
obtaining the restored semantic feature by performing the semantic restoration on the sample image employing the semantic decoding network based on the second fused feature; and
obtaining the restored image by performing the image restoration on the sample image employing the pixel decoding network based on the second fused feature.

12. The method of claim 11, wherein the token extraction model further comprises: a multi-layer perceptron network and a quantization network; and
obtaining the restored semantic feature by performing the semantic restoration on the sample image employing the semantic decoding network based on the second fused feature comprises:
obtaining a second sampling feature by performing downsampling on the second fused feature employing the multi-layer perceptron network;
obtaining a sample image token sequence by performing quantization processing on the second sampling feature employing the quantization network; and
obtaining the restored semantic feature by performing the semantic restoration on the sample image employing the semantic decoding network based on the sample image token sequence.

13. The method of claim 1, wherein the image processing task comprises an image generating task or an image editing task and the input content comprises the image-text fusion sequence; and
obtaining the joint feature representation comprising the multimodal semantic information by performing the cross-modal semantic modeling on the input content comprises:
extracting a third text semantic feature of a text space and a third image semantic feature of an image space from the image-text fusion sequence respectively;
establishing a second semantic correlation relationship between the third text semantic feature and the third image semantic feature; and
generating the joint feature representation comprising the multimodal semantic information by fusing the third text semantic feature and the third image semantic feature based on the second semantic correlation relationship.

14. The method of claim 1, wherein the image processing task comprises an image generating task, and the input content comprises the first text token sequence; and
obtaining the joint feature representation comprising the multimodal semantic information by performing the cross-modal semantic modeling on the input content comprises:
obtaining a fourth text semantic feature of a text space by performing semantic encoding on the first text token sequence based on contextual information of the first text token sequence;
obtaining a fourth image semantic feature of an image space by performing cross-modal semantic modeling on the fourth text semantic feature; and
generating the joint feature representation based on the fourth text semantic feature and the fourth image semantic feature.

15. The method of claim 14, wherein generating the output content adapted to the image processing task based on the joint feature representation comprises:
obtaining a second image token sequence corresponding to at least one resolution by performing multi-round iteration on the joint feature representation based on an autoregressive mechanism; and
generating a second target image based on the second image token sequence corresponding to the at least one resolution.

16. The method of claim 15, wherein generating the second target image based on the second image token sequence corresponding to the at least one resolution comprises:
for any second image token sequence, determining a semantic level of the second image token sequence based on a semantic feature of the second image token sequence;
obtaining a third image token sequence by performing upsampling on the second image token sequence based on the semantic level; and
obtaining the second target image by fusing respective third image token sequences.

17. An electronic device, comprising:
at least one processor; and
a memory communicatively coupled to the at least one processor;
wherein the memory stores instructions executable by the at least one processor, and the instructions are executed by the at least one processor to cause the at least one processor to execute a method for processing an image, wherein the method comprises:
obtaining an input content adapted to an image processing task, wherein the input content comprises at least one of: a first text token sequence, a first image token sequence, or an image-text fusion sequence;
obtaining a joint feature representation comprising multimodal semantic information by performing cross-modal semantic modeling on the input content, wherein the multimodal semantic information indicates a semantic correlation relationship of the input content in different modalities; and
generating an output content adapted to the image processing task based on the joint feature representation.

18. A non-transitory computer-readable storage medium for storing computer instructions, wherein the computer instructions are configured to cause the computer to execute a method for processing an image, wherein the method comprises:
obtaining an input content adapted to an image processing task, wherein the input content comprises at least one of: a first text token sequence, a first image token sequence, or an image-text fusion sequence;
obtaining a joint feature representation comprising multimodal semantic information by performing cross-modal semantic modeling on the input content, wherein the multimodal semantic information indicates a semantic correlation relationship of the input content in different modalities; and
generating an output content adapted to the image processing task based on the joint feature representation.

19. A computer program product, comprising a computer program that, when executed by a processor, realizes the method of claim 1.
